(19) United States
(12) Patent Application Publication
(10) Pub. No.: US 2003/0159372 A1
(43) Pub. Date: Aug. 28, 2003

(54) Storm panel

(76) Inventor: Joseph V. Motro, Merritt Island, FL (US)

Correspondence Address: JOHN L. DEANGELIS, JR., ESQ., BEUSSE BROWNLEE BOWDOIN & WOLTER, P.A., 390 NORTH ORANGE AVENUE, SUITE 2500, ORLANDO, FL, 32801, US

(21) Appl. No.: 10/081,588

(22) Filed: Feb. 22, 2002

(51) Int. Cl. E06B 3/26; E06B 3/00; E04B 1/00

(52) U.S. Cl. 52/202; 52/222

(57) ABSTRACT

A storm panel is formed of a film material for providing protection to the frangible portions of a structure during extreme weather conditions, especially protecting the frangible portions against debris carried by high winds. The panel comprises at least two laminated sheets of the film material, and in one embodiment further including a layer of reinforcing fibers disposed therebetween, and further comprising supporting track members on opposing sides of the laminated sheets. Installation as the extreme weather approaches is relatively easy as the storm panel is light and readily attached to the structure adjacent the frangible portion using the track members.

### FIELD OF THE INVENTION

This invention relates to a hurricane or storm panel for protecting glass windows, doors, and similar openings in a structure, and more specifically to a hurricane or storm panel constructed of sheets of laminated polyester film with fiber or ribbon material sandwiched therebetween.

### BACKGROUND OF THE INVENTION

Exterior windows, doors, and sliding glass doors mounted within exterior walls of commercial or residential structures provide a weather-tight barrier against uncomfortable weather conditions, including excessive temperatures and the intrusion of high winds and precipitation into the structure. Advantageously, these windows and doors permit viewing from both the inside and the outside of the structure and can be opened during favorable weather conditions, but these features also require that the windows and doors be constructed from a transparent material that may not adequately withstand severe weather conditions. It is possible to construct a window or sliding glass door that provides a substantial barrier against potentially destructive weather conditions, such as laminated or high-impact resistance glass, but these materials tend to be expensive and may thus be cost prohibitive for dwellings and buildings that have a large number of windows and glass doors.

Extreme storm conditions characterized by strong winds, rain, airborne debris, and hail occur frequently in various locales. Hurricane force winds of greater than 74 miles per hour are not unexpected during the Atlantic Coast hurricane season. Such conditions can also occur during a tornado or a locally strong thunderstorm. Studies of structural damages resulting from recent hurricanes, indicate that most of the damage is caused by the wind or wind-borne debris that breaks through window or door glass, breaching the structural integrity and allowing wind and rain to penetrate into the building.

It is known that a pressure differential is created as the faster air-flow moving over the curved top surface of an airplane wing forms a low pressure region, while a high pressure region is formed by slower moving air under the wing. This pressure differential, known as the Bernoulli effect, creates the aircraft lift. When the structural integrity has been breached, by blowing out a window, for example, the Bernoulli effect can occur inside the structure where slower moving high pressure air under a roof is unbalanced against the faster moving lower pressure air above the roof. The resulting pressure differential can cause the roof to lift from the structure. Also, high pressure wind driven perpendicularly against the interior surface of an exterior structural wall can cause failure of a sidewall. Once a window, sidewall, or roof of a structure is destroyed, the integrity of the entire structure is compromised, permitting the wind and rain to deluge the interior surfaces and contents, causing considerable damage and loss of property.

Even in those situations where the structure remains intact, winds of gale force and stronger drive rain and debris against window glass, doors, and their sealing members. Small particles, such as sand and gravel, can damage glass surfaces due to the force generated as the particles are driven by high winds. In a strong storm, yard debris, outdoor furniture, and other outdoor items can become airborne missiles when driven by the high winds. These missiles penetrate unprotected glass surfaces, such as windows and doors, breaching the structural integrity and leading to potential roof lift, as discussed above, and damage to the structure interior and possessions due to wind and rain intrusion.

Building standards or building codes establish requirements for the various systems of a building, including, for example, the structural, electrical and plumbing systems. In hurricane-prone regions, the building code wind load requirements are designed to protect a structure against the effects of wind and flying debris to a specified wind speed value. For example, a current building standard for structural glass panels requires that the glass panel in a window or door be protected from a first blow from the end of a 2×4 plank (weighing nine pounds) that strikes the center of the glass panel at a speed of 34 mph, and a second blow from the same plank directed to a corner area of the glass panel. Thus the glass panel can be designed to satisfy these requirements or can be protected by a shutter or panel that satisfies these requirements. Although this standard has governed new construction in certain areas for several years, it is now being expanded in scope to include geographical areas previously subject to lower wind-borne debris requirements.

The use of expensive laminate glass products, in place of the conventional glass panels, may satisfy this building standard. Alternatively, the standard allows construction of the structure with the conventional glass windows and doors plus removable protective shutters, so long as the protective shutters can be installed with relative ease by the homeowner when a storm is approaching. Consequentially, it is preferable for the protective shutter to be relatively light and easy to handle and install.

Prior art folding or roll-type window shutters are typically constructed of individual slats formed from wood, steel, aluminum, plastic or other structurally rigid materials. The shutter consists of parallel slats hinged together such that they unfold to overlay the window. Generally, these shutters are stored within a housing installed above the glass element. When required to protect the glass, they are withdrawn from the storage housing and lowered over the glass by a mechanical crank or electrical motor drive. The storage housing is relatively large and unsightly, and represents a distraction from an otherwise aesthetically pleasing structure.

Another disadvantage of these prior art shutters is their opaqueness to outside light. This is especially problematic in the event that the electrical power supply to the structure is disrupted during inclement weather conditions, rendering the interior without both natural and artificial light. An opaque shutter also prevents the occupants from observing their outside surroundings, possibly raising their anxiety level during a severe weather event.

Another simple and relatively inexpensive glass protection material is the plywood sheet. When a hurricane approaches, the building supply stores are invaded by homeowners purchasing 4×8 plywood sheets to nail over windows and sliding glass doors. These large sheets are cumbersome, must be cut to fit the window size and are difficult and dangerous to install, especially as the wind velocity increases as the storm approaches. Installation is typically accomplished by nailing or screwing the sheets to the structural surfaces adjacent the window or door, permanently marring these surfaces. Like the roll-type or folding shutters, the plywood sheets block the exterior light from entering the building, and thus many residents wait until the storm is close before undertaking the installation process, when the high winds further exacerbate installation.

### BRIEF SUMMARY OF THE INVENTION

A storm panel constructed according to the teachings of the present invention provides increased protection against flying debris during a storm and is easily installed by a resident or tenant over a window or glass panel when a severe storm is expected. In one embodiment, the present invention also satisfies the building code requirements for impact resistance to flying debris as set forth above. The storm panel comprises one or more laminated sheets of polyester (or other plastic type) film, forming a planar multi-ply panel. In one embodiment, an arrangement of yarns, ribbons or fibers are disposed between two or more of the multiple plies to provide additional strength and stiffness. In the preferred embodiment, the panel is constructed from two plies. Mounting tracks fixedly engage the left and right or the top and bottom edges of the panel and are mounted to the structure with mechanically-anchored fasteners. Generally, the fasteners are installed in the structure during construction, or can be installed later by the homeowner, providing quick and easy installation of the storm panel, by engaging the tracks with the fasteners, when a storm approaches. In another embodiment, a center stile, in the form of a bar, rod or I-beam preferably formed from aluminum, is advantageously installed behind the storm panel to further limit deflection, especially for large windows or glass panels.

### BRIEF DESCRIPTION OF THE DRAWINGS

The present invention can be more easily understood and the further advantages and uses thereof more readily apparent, when considered in view of the detailed description of the invention below and the following figures in which:

FIG. 1 illustrates a storm panel constructed according to the teachings of the present invention;

FIG. 2 illustrates constituent layers for one embodiment of the storm panel of FIG. 1;

FIGS. 3A-3D illustrate orientations for the reinforcing material layer of the storm panel of FIG. 1;

FIG. 4 is a top view of a track for attaching the storm panel of FIG. 1;

FIG. 5 illustrates film material and a support member for the storm panel of FIG. 1;

FIGS. 6 and 7 are cross-sectional views of a second and third embodiment of a track for attaching the storm panel of FIG. 1;

FIG. 8 illustrates a second embodiment of film material and a support member for the storm panel of FIG. 1;

FIG. 9 is a cross-sectional view of a fourth embodiment of a track for attaching the storm panel of FIG. 1;

FIG. 10 illustrates an embodiment for the storm panel of FIG. 1 including a center stile.

In accordance with common practice, the various described invention features are not drawn to scale, but are drawn to emphasize specific features relevant to the invention. Reference characters denote like elements throughout the figures and text.

### DETAILED DESCRIPTION OF THE INVENTION

Before describing in detail the particular hurricane or storm panel in accordance with the present invention, it should be observed that the present invention resides primarily in a novel combination of hardware elements for protecting glass structural panes such as windows, sliding glass doors and entry doors having glass panes. Accordingly, the hardware components are represented by conventional elements in the drawings, showing only those specific details that are pertinent to the present invention so as not to obscure the disclosure with structural details that will be readily apparent to those skilled in the art having the benefit of the description herein.

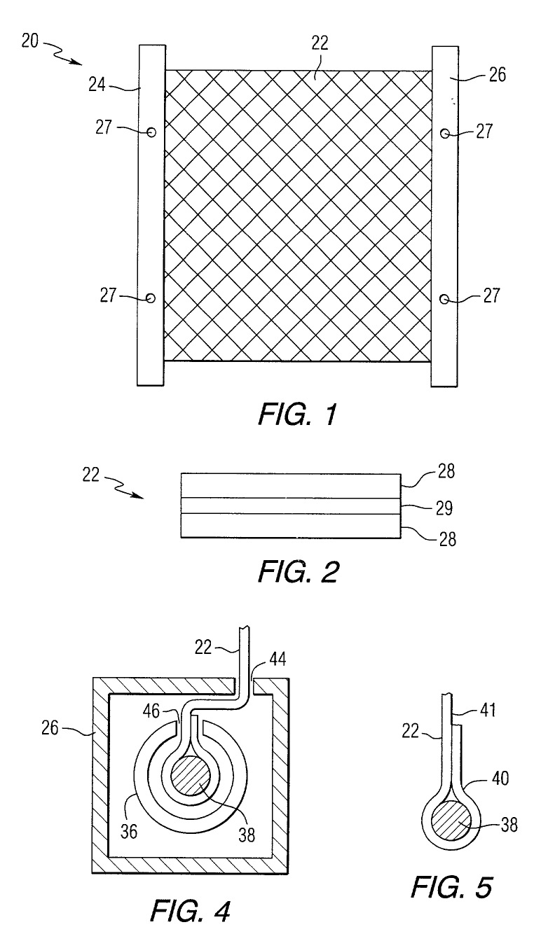

As shown in FIG. 1, a storm panel 20 constructed according to the teachings of the present invention comprises a panel 22 disposed between a left track 24 and a right track 26. The storm panel 20 is mounted to the structure's exterior walls adjacent glass panes or other frangible material for protection from breakage caused by flying debris during a storm or hurricane, by attaching the left and right tracks 24 and 26 to the structural walls adjacent the area to be protected. In one embodiment, the left and the right tracks 24 and 26 are attached by passing a fastener through each hole 27 as illustrated in FIG. 1, and further fixing the fastener to the structure. The details of the attachment mechanism according to the present invention are described further below. The left and right tracks 24 and 26 are spaced apart when mounted to the structure such that the panel 22 is in tension. Further, the material selected for the panel 22 has a relatively high stretch resistance and thus can be tensioned to minimize the deflection when under load, i.e., when impacted by flying debris or high-speed wind conditions. Advantageously, the panel 22 can be easily cut-to-shape by using a blade or scissors, thus simplifying the process of mounting the panel 22 to the left and right tracks 24 and 26.

In one embodiment, the panel 22 comprises two film sheets 28 (See FIG. 2.), where each film sheet 28 comprises one or more planar plies formed from a film material such as Mylar® transparent polyester film available from DuPont de Nemours of Wilmington, Del. It is known that Mylar® film is a brand name for one type of biaxial thermoplastic film material referred to generically as polyester, i.e., polyethylene terephthalate (PET), and thus any polyester-type material can be used. The film sheets 28 can also be formed from materials selected from any of the following classes: polyester, polycarbonate, polyimide and fluropolymer. Generally, any material with a relatively high resistance to stretch (a property known as the initial modulus) and a high strength can be used to form the panel 22. A high resistance to cracking and tearing is also desirable. Other suitable materials include: liquid-crystal polymer films such as Vectra film available from Hoechst-Celanese of Edmonton, Alberta, polyvinyl fluoride (PFV) films (from the fluropolymer class), such as Tedlar film available from DuPont de Neumours, polyethylene naphthalate (PEN) films and polyethermidie (PEI). Techniques and processes for laminating two or more films formed from these materials are known in the art.

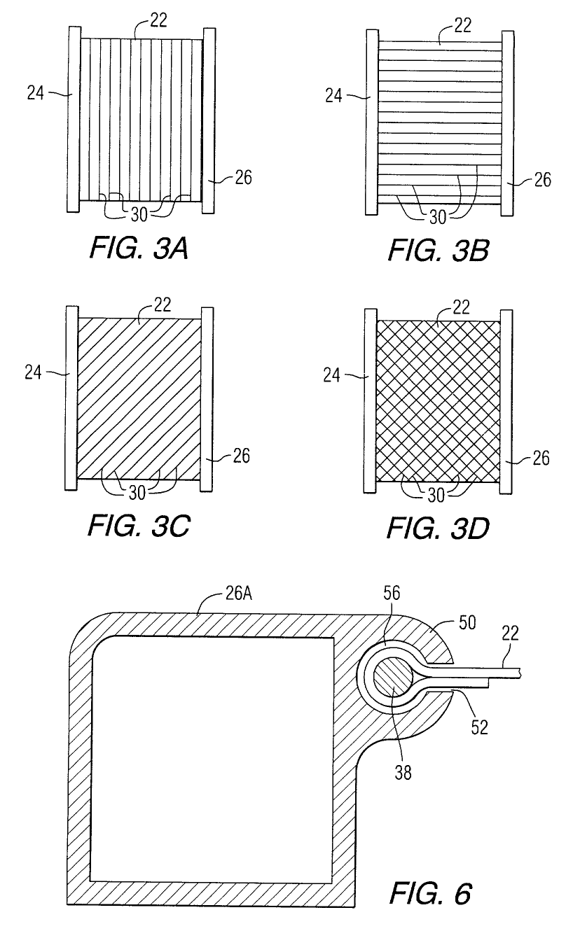

In one embodiment, the panel 22 comprises two plies of the film sheets 28, as described above, separated by a layer of fiber strands 30, with each strand comprising a plurality of individual fibers, to form a reinforcing material layer 29. See FIGS. 2 and 3. The reinforcing material layer 29 provides additional strength and stiffness to the panel 22. As illustrated in FIGS. 3A through 3D, the fiber strands 30 can be oriented in a substantially parallel vertical, horizontal, or diagonal direction, or in the form of intersecting strips. The orientation, spacing and constituent material (as discussed further below) of the fiber strands 30 are matters of design choice, determined by the desired stretch resistance and strength for the panel 22. The fiber strands 30 can also be formed as a woven scrim. In the embodiment of a diagonal grid of intersecting strips, such as illustrated in FIG. 3D, the reinforcing material increases the diagonal stability of the panel 22 and provide a rip stop function. That is, rips in the panel 22 are confined to areas between diagonal strips. In cross-section, the fiber strands 30 can be circular (e.g., yam) or relatively flat (e.g., ribbon), with the selection based on the desired properties for the panel 22.

Candidate materials for the fiber strands 30 include: Vectran (a liquid crystal polymer fiber material available from Hoescht-Celanese), PBO (poly-paraphenylene benzobisthiazole plastic fiber), Dacron® or Kevlar® material available from Dupont de Nemours, Pentex™ material available from Honeywell Corporation of Morristown, N.J., aramid products such as those available from Teijin Twaron BV of the Netherlands, a polyethylene product such as Honeywell Spectra™ material, polypropylene materials or polyvinyl materials. Carbon, nylon, or any other fibrous materials capable of providing additional strength and stiffness to the laminated polyester film and formable into a yarn or ribbon shape can also be used to form the reinforcing material layer 29. Processes and techniques for laminating films with reinforcing material therebetween, are known in the art.

A material suitable for use as a panel 22, including the reinforcing material layer 29 disposed between the two film sheets 28 is available from Dimension Polyant of Putnam, Conn. and from Bainbridge International of Canton, Mass. A panel thickness in the range or about 5 and 10 mils is generally considered satisfactory. In one embodiment, a 7 mil thick panel is used

As can be appreciated by those skilled in the art, the choice of a specific material thickness is dependent on the properties of the material employed. Thus the choice of material for the film sheets 28, the inclusion (or exclusion) of a reinforcing material layer 29, the material properties of the various layers and the desired properties for the panel 22, are all factors that influence the material type and thickness for the various material layers.

In one embodiment, it is desirable for the panel 22 to be transparent to allow outside light into the structure. Under severe weather conditions, power outages are probable and thus the structure interior can be illuminated by sunlight from outside. A polyester film (polyester monofilm or PET) is especially suitable for this application. However, this transparency property is not required for protecting the glass door or window against flying debris.

In another embodiment, the required strength and stretch properties can be achieved by forming the panel 22, specifically the film sheets 28, from multiple laminated plies of one or more of the various film materials identified above, such as polyester film material. This embodiment may obviate the need for the reinforcing material layer 29.

In yet another embodiment, the panel 22 comprises an ultraviolet light-resistant material. The UV resistance of a material is a measure of the time required for the material to lose 50% of its initial modulus when continuously exposed to UV radiation. Thus the use of a material with a relatively high UV resistance extends the usable life of the panel 22. One technique for increasing UV resistance includes the use of a UV-resistant material layer on the outside surface of the panel 22, such as Dupont Tedlar® polyvinyl fluoride (PVF). The PVF material can be used in addition to or in lieu of the outside facing layer formed from one of the film materials identified above. Thus in one embodiment, the panel 22 is formed from a lamination of a film layer, the reinforcing material layer 29 and a PVF layer for UV protection. When two film layers plus the reinforcing material layer 29, form the panel 22, each of the film layers is about 3.5 mils thick. In the embodiment where the outside-facing film layer is replaced with a PVF layer, the other film is about 6 mils thick, as the PVF material does not exhibit the same stretch and strength properties as the film materials comprising the layers 28. In another embodiment, the UV resistance can be improved by the use of a tinted adhesive or tinted material layer between any two of the laminated layers. In still another embodiment, one or more of the material layers comprising the panel 22 can be treated with an ultraviolet resistant material.

The left and right tracks 24 and 26 capture and tension the panel 22. In one embodiment, the left and right tracks 24 and 26 are constructed from a hollow metallic bar having a generally rectangular cross-section. Exemplary materials for constructing the left and right tracks 24 and 26 comprise extruded aluminum, carbon steel or stainless steel. The left and right tracks 24 and 26 are similarly constructed; details of the right track are described below. As illustrated in a cross-sectional view of FIG. 4, the right track 26 includes a capture mechanism 36 for engaging a rod 38 fixedly attached to one edge of the panel 22. As shown in FIG. 5, this fixed attachment can be accomplished by wrapping a free end 40 of the panel 22 circumferentially around the rod 38 and attaching the free end 40 to the rear surface 41 of the panel 22 using any of the known adhesives, tapes or thermal processes suitable for the material employed, including double-coated adhesive tape, available from Minnesota Mining and Manufacturing Company of St. Paul, Minn. The rod 38 comprises a solid or hollow elongated circular member (e.g., a dowel) formed from wood, aluminum, steel, plastic or another suitable material.

Returning to FIG. 4, the right track 26 includes a slot 44, and the capture mechanism 36 includes a slot 46. The panel 22 passes through both the slots 44 and 46 as shown. After the left and the right tracks 24 and 26 are attached to the structure, the rod 38 engages the capture mechanism 36, and the assembly is slidably engaged into the right track 26. The other end of the panel 22 is similarly engaged in the left track 26. The left and the right tracks are spaced apart such that the installed panel 22 is in tension, and the capture mechanism 36 in each track 24 and 26 is urged against the inside surface of its respective track.

Another embodiment of a right track 26A is illustrated in the cross-sectional view of FIG. 6. The left track 24 is similarly constructed. The right track 26A includes a generally circularly hollow capture structure 50, which further includes a slot 52 and defines a generally circular opening 56. The rod 38 and the attached panel 22 are slidably engaged within the opening 56, with the panel 22 extending through the slot 52.

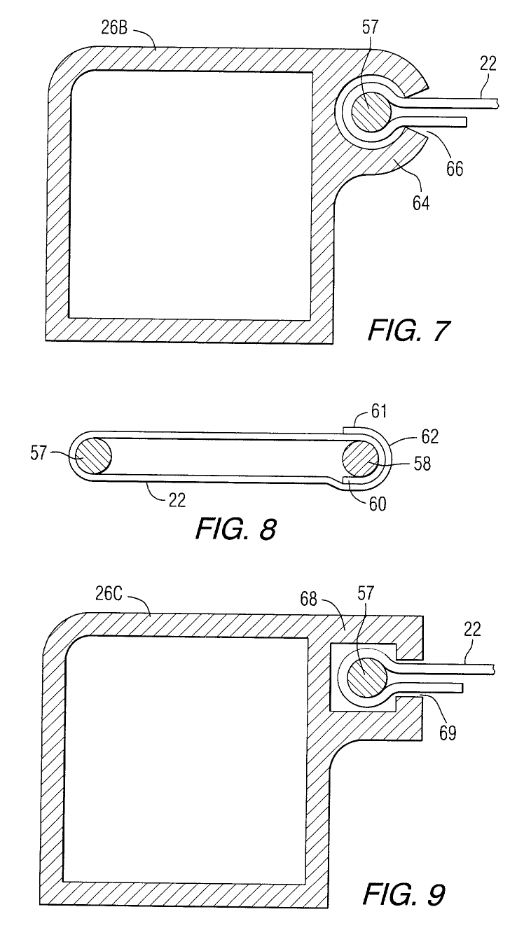

Yet another embodiment of the right track 26B is illustrated in the cross-sectional view of FIG. 7. For this embodiment, the panel 22 is captured by two rods 57 and 58, as illustrated in FIG. 8, and ends 60 and 61 are joined along an area of intersection 62. Several known adhesives, tapes and thermal processes are available for joining ends 60 and 61, including double-coated tape or a hot-melt adhesive. Returning to FIG. 7, the rod 57 is engaged within a capture mechanism 64, including an angular opening 66 for restraining the rod 57 within the capture mechanism 64. The left track is similarly constructed for engaging the rod 58 at the opposite end of the panel 22. Although the capture mechanism comprises an arcuate shape as shown in FIG. 7, this is not necessarily required. The embodiment of FIG. 9 illustrates a rectangular capture mechanism 68 including a gap 69 in a right track 26C for capturing the rod 57. Other slit and capture configurations cam be utilized in addition to those illustrated herein.

The left and right tracks 24 and 26 are attached to the structure walls using any one of several known attachment techniques. In one embodiment, holes 27 (see FIG. 1) are formed within the left and right tracks 24 and 26 for receiving a bolt or screw that engages a threaded member installed in the structural wall, such as a dropin or calk-in anchor. The calk-in anchor is usable in concrete, brick, block or stone. Installation of a calk-in anchor begins by drilling a hole in the base material to the desired depth. The anchor is inserted into the hole and set in place with a setting tool that drives the anchor sleeve over the anchor cone. A screw or bolt is inserted into the holes 27 of the left and right tracks 24 and 26 and screwed into the anchor.

A known slotted brass wood bushing is suitable for attaching the left and right tracks 24 and 26 to a wood-frame structure. As can be appreciated by those skilled in the art, the specifics for anchoring the left and right tracks 24 and 26 to the wall are dependent on the construction materials used to form the wall and the desired anchoring system, and thus are not considered a limiting or controlling feature of the present invention. Various known types of drop-in or lag shield anchors are also suitable for securing the storm panel 20 to the structure over the glass door or pane.

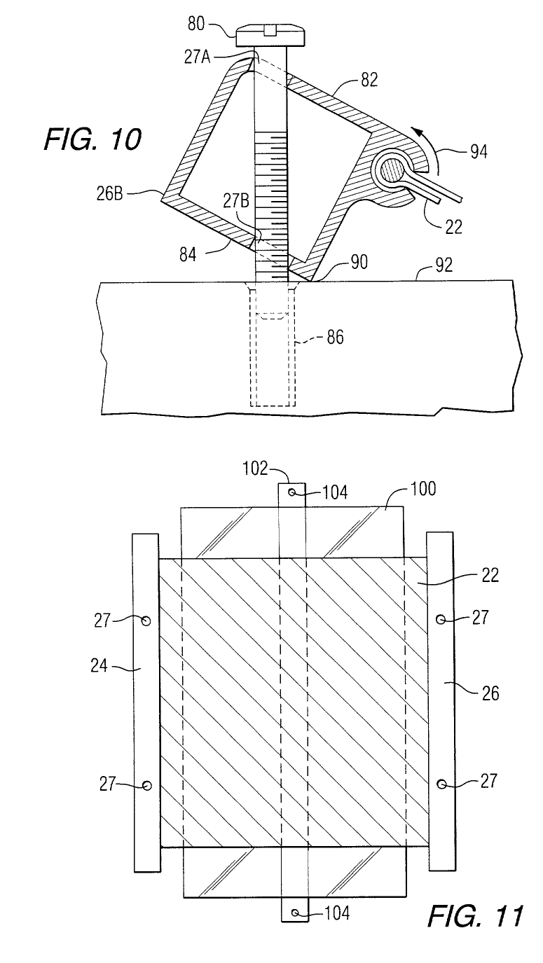

FIG. 10 illustrates one method for attaching the left and right tracks 24 and 26 to the structure and the tensioning of the panel 22 that occurs as the bolt or screw is driven into the structural wall. FIG. 10 is an elevation view looking down at the right track 26B from above. A screw 80 is inserted into holes 27A and 27B in the front surface 82 and the rear surface 84, respectively, of the right track 26B and further inserted into a calk-in anchor 86. A corner 90 of the right track 26B contacts the wall surface 92. As the screw 80 is tightened into the calk-in anchor 86, the right track 26B rotates about the corner 90, as depicted by the arrowhead 94, until the rear surface 84 is adjacent the wall surface 92. The left track 24B is similarly installed. Thus the left and right tracks 24B and 26B are displaced away from each other as the screw is tightened, and the panel 22 is tensioned as a result.

The dimensions of the panel 22 and the distance between the fastener locations are determined in advance based on the width of the window or door glass panel, such that when the left and right tracks 24 and 26 are in position, the panel 22 is properly tensioned to deflect debris that is driven against the panel 22 during a storm or hurricane.

In another mounting method one of the left and the right tracks 24 and 26, includes circular holes 27 and is mounted to the respective side of the window or glass pane to be protected. The holes in the other track are formed as elongated slots. After fasteners are inserted into the slots of the second-mounted track and then loosely into the wall anchors, the installer urges the second-mounted track away from the first-mounted track, causing the former track to move with respect to the loosely held fasteners. While holding the second-mounted track in this position, the fasteners are firmly engaged into the structural wall.

Generally, the storm panel 20 is formed in the shape of a rectangular. To retain the parallel track mounting system described herein for non-rectangular windows or glass panes, the panel material is sized based on the maximum horizontal and vertical dimension to cover the window or glass pane, recognizing that the panel 22 will overlay structural wall surface due to the non-rectangular shape of the region to be protected.

Advantageously, the panel 22 is formed of a transparent material for admitting natural light into the structure. This is especially advantageous in the event the storm causes a power failure and the loss of artificial lighting systems.

In yet another embodiment of the present invention, the panel 22, which is formed of flexible material, can be embodied in a roll-up shutter system, i.e., wherein the panel 22 is stored in a housing, including a rod or bar onto which the panel 22 is wound during storage. The housing is located above the window or glass pane, and when required to protect the glass, the panel 22 is unwound from the storage housing downwardly across the glass pane, then tensioned and affixed to the structural wall immediately below the glass. The method of unwinding the panel can include manually cranking or motor-driving the rod on which the panel 22 is wound within the storage housing. The method for attaching the panel 22 to the structure wall includes any of the know anchor mechanisms, including those described herein. Tensioning the panel is accomplished by braking the unwinding mechanism and applying a tension force to the panel 22 before attaching it to the structural walls.

It is known that certain building codes require that all bedrooms in a residence structure have two separate exits. Typically, to comply with this requirement, each bedroom has at least one egress window. According to such codes, the window is required to have a clear opening of at least 5.0 square feet on the first floor and 5.7 square feet for upper floor windows. Further according to these building codes, if a shutter is affixed over the designated egress window, the shutter must be removable from the structure interior. Many prior art shutters are attached (by bolting or screwing) from outside the window and thus cannot be removed from the interior. However, a shutter constructed according to the teachings of the present invention can be adapted to comply with this egress requirement. In this embodiment, a cutting tool is demountably attached (for example, using complementary hook and loop material on the cutting tool and the attachment surface) to the interior surface of the panel 22 or to one of the left or right tracks 24 and 26. In an emergency, the cutting tool is detached from the attachment surface and employed to slit the panel 22 to provide an egress path to the outside.

FIG. 11 is a front view of a window 100 protected by a storm panel 20 constructed according to the teachings of the present invention, and further including a center stile 102 extending beyond the bottom and top of the window 100, and attached to the structure above and below the window by any suitable technique, including the calk-in, drop-in or lag shield anchors or the slotted brass bushings discussed above. The center stile 102 includes holes 104 for engagement with any one of these fasteners. The center stile 102 is formed from a rod, bar or I-beam to provide an outwardly directed force against the rear surface of the panel 22 thereby reducing deflection of the panel under wind load. It is not necessary to attach the center stile 102 to the panel 22, since the window 100 will be subjected to forces that drive the rear surface of the panel 22 against the stile 102.

While the invention has been described with reference to preferred embodiments, it will be understood by those skilled in the art that various changes may be made and equivalent elements may be substituted for the elements thereof without departing from the scope of the present invention. In addition, modifications may be made to adapt a particular situation to the material teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A storm panel for protecting frangible portions of a structure, comprising:
first and second tracks for mounting in substantially parallel orientation adjacent opposing edges of a frangible portion; and
a film comprising a plurality of bonded material plies disposed between and attached to said first and said second tracks for overlying the frangible portion.

2. The storm panel of claim 1 wherein a first edge of the film is slidably engaged within the first track and a second parallel edge of the film is slidably engaged within the second track.

3. The storm panel of claim 2 wherein the first film edge and the second film edges are fixedly attached to a first and a second elongated member, respectively, and wherein said first and said second elongated members are slidably engaged within and captured by the first and the second tracks, respectively, such that the film is tensioned over the frangible portion.

3. The storm panel of claim 1 wherein the film comprises at least two bonded material plies.

4. The storm panel of claim 1 wherein the material of the bonded material plies is selected from among polyester, polycarbonate, polyimide, and fluropolymer.

5. The storm panel of claim I wherein the film is in the shape of a closed loop, and further comprises a first and a second elongated member disposed at opposing ends of the loop, wherein said first and said second elongated members are captured by the first and the second tracks, respectively, for tensioning the film over the frangible portion.

6. The storm panel of claim 5 wherein the closed loop is formed from a film sheet having first and second substantially parallel edges bonded together to form the closed loop.

7. The storm panel of claim 5 wherein the first and the second elongated members are selected from among a first and a second circular rod, and a first and a second rectangular bar.

8. The storm panel of claim 5 wherein the first and the second tracks each comprise a complementary capture mechanism for fixedly engaging the first and the second elongated members.

9. The storm panel of claim 1 including a cutting device demountably attached to the interior facing surface of the film such that said cutting device is operable to cut the film from within the structure when the frangible portion is open.

10. The storm panel of claim 1 wherein the first and the second tracks are mounted on opposing left and right side edges of the frangible portion.

11. The storm panel of claim 1 wherein the first and the second tracks are mounted on opposing top and bottom edges of the frangible portion.

12. The storm panel of claim 1 wherein the first and the second tracks are formed from a material selected from among extruded aluminum, stainless steel and carbon steel.

13. The storm panel of claim 1 wherein the film comprises two plies of bonded material and a reinforcing layer disposed therebetween.

14. The storm panel of claim 13 wherein the material of the reinforcing layer comprises a plurality of fibers oriented in a spaced-apart parallel configuration, wherein the fibers comprise material selected from among, liquid crystal polymer, poly-paraphenylene benzobisthiazole, aramid, polyethylene, polypropylene, polyvinyl, carbon, nylon, polyester.

15. The storm panel of claim 13 wherein the material of the reinforcing layer comprises a plurality of fibers in an intersecting pattern, wherein the fibers comprise material selected from among, liquid crystal polymer, poly-paraphenylene benzobisthiazole, aramid, polyethylene, polypropylene, polyvinyl, carbon, nylon, polyester.

16. The storm panel of claim 13 wherein the material of the reinforcing layer comprises a plurality of fibers selected from among yarn fibers and ribbon fibers.

17. The storm panel of claim 1 wherein the film comprises at least two material plies and a reinforcing material disposed between two adjacent surfaces of the at least two material plies.

18. The storm panel of claim 1 wherein the film is substantially transparent.

19. The storm panel of claim 1 wherein the film has a relatively high stretch resistance.

20. The storm panel of claim 1 wherein the film is held in tension by the application of tension-directed forces by the first and the second tracks so as to reduce the deflection of the film toward the frangible portion when the film is subjected to an inwardly directed force.

21. The storm panel of claim 1 further comprising a storage housing adjacent the frangible portion and a roller therein, wherein a first edge of the film is secured to said roller and stored in a rolled configuration within said housing, and wherein the film is discharged from said housing to cover the frangible portion, and wherein the discharged film is secured to the first and the second tracks.

22. The storm panel of claim 1 further comprising a support stile disposed over the frangible portion to limit the deflection of the film toward the frangible portion.

23. The storm panel of claim 22 wherein the support stile is oriented parallel to the first and the second tracks and secured adjacent the frangible portion.

24. The storm panel of claim 1 wherein at least one of the bonded material plies includes an ultra-violet resistant material.
